(19) United States
(12) Patent Application Publication
(10) Pub. No.: US 2020/0150898 A1
(43) Pub. Date: May 14, 2020

(54) MEMORY SYSTEM AND OPERATING METHOD THEREOF

(71) Applicant: SK hynix Inc., Gyeonggi-do (KR)

(72) Inventors: Eu Joon BYUN, Gyeonggi-do (KR); Byung Jun KIM, Gyeonggi-do (KR); In JUNG, Gyeonggi-do (KR); Seung Ho CHOI, Gyeonggi-do (KR)

(21) Appl. No.: 16/231,880

(22) Filed: Dec. 24, 2018

(30) Foreign Application Priority Data
Nov. 12, 2018 (KR) 10-2018-0137898

(51) Int. Cl. G06F 3/06; G06F 12/10

(52) U.S. Cl. CPC G06F 3/0659; G06F 3/0604; G06F 2212/202; G06F 12/10; G06F 2212/1041; G06F 3/0679

(57) ABSTRACT

Provided is an operating method of a memory system which includes a plurality of nonvolatile memory devices; and a controller configured to control the nonvolatile memory devices to store data therein. The operating method may include: receiving, by the controller, a write request for logical addresses from a host device; determining, by the controller, whether a start logical address among the logical addresses satisfies an alignment condition, the start logical address indicating where a write operation is to be performed in a target nonvolatile memory device among the nonvolatile memory devices; determining, by the controller, target data by determining one or more target logical addresses among the logical addresses through an alignment operation, when the start logical address does not satisfy the alignment condition; and controlling, by the controller, the target nonvolatile memory device to perform the write operation on the target data.

### CROSS-REFERENCE TO RELATED APPLICATION

The present application claims priority under 35 U.S.C. § 119(a) to Korean application number 10-2018-0137898, filed on Nov. 12, 2018, in the Korean Intellectual Property Office, which is incorporated herein by reference in its entirety.

### BACKGROUND

### 1. Technical Field

Various embodiments generally relate to a memory system, and more particularly, to a memory system including a nonvolatile memory device.

### 2. Related Art

A memory system may be configured to store data provided from a host device in response to a write request of the host device. Also, the memory system may be configured to provide data stored therein to the host device in response to a read request of the host device. The host device may include a computer, digital camera, mobile phone or the like, as an electronic device capable of processing data. The memory system may be embedded in the host device or separately fabricated and connected to the host device.

### SUMMARY

Various embodiments are directed to a memory system capable of performing sequential read operations with improved performance through an alignment operation, and an operating method thereof.

In an embodiment, there is provided an operating method of a memory system which includes a plurality of nonvolatile memory devices; and a controller configured to control the nonvolatile memory devices to store data therein. The operating method may include: receiving, by the controller, a write request for logical addresses from a host device; determining, by the controller, whether a start logical address among the logical addresses satisfies an alignment condition, the start logical address indicating where a write operation is to be performed in a target nonvolatile memory device among the nonvolatile memory devices; determining, by the controller, target data by determining one or more target logical addresses among the logical addresses through an alignment operation, when the start logical address does not satisfy the alignment condition; and controlling, by the controller, the target nonvolatile memory device to perform the write operation on the target data.

In an embodiment, a memory system may include: a plurality of nonvolatile memory devices; and a controller configured to control the nonvolatile memory devices to store data therein, wherein the controller receives a write request for logical addresses from a host device, determines whether a start logical address among the logical addresses satisfies an alignment condition, the start logical address indicating where a write operation is to be performed in a target nonvolatile memory device among the nonvolatile memory devices, determines target data by determining one or more target logical addresses among the logical addresses through an alignment operation when the start logical address does not satisfy the alignment condition, and controls the target nonvolatile memory device to perform the write operation on the target data.

In an embodiment, a memory system may include: a plurality of nonvolatile memory devices; and a controller configured to control the nonvolatile memory devices under control of a host device, wherein the controller includes: a host interface configured to receive a write request for logical addresses from the host device; an alignment processor configured to compare a start logical address among the logical addresses with a plurality of reference logical addresses in response to the write request, the start logical address indicating where a write operation is to be performed in a target nonvolatile memory device among the nonvolatile memory devices, determine one or more target logical addresses among the logical addresses according to the comparison result, and determine target data based on the target logical addresses; and a memory interface configured to control the target nonvolatile memory device to perform the write operation on the target data.

In an embodiment, a memory system may include: a plurality of nonvolatile memory devices; and a controller suitable for: receiving logical addresses corresponding to a write request; determining whether a start logical address among the logical addresses indicates an alignment address based on a reference logical address; when it is determined that the start logical address does not indicate the alignment address, determining target write data having an alignment data size based on the start logical address and the reference logical address, the target write data including write data corresponding to the target logical address; and controlling a target nonvolatile memory device, among the plurality of nonvolatile memory devices, to perform a write operation on the target write data.

### BRIEF DESCRIPTION OF THE DRAWINGS

FIG. 1 is a block diagram illustrating a memory system in accordance with an embodiment.

FIG. 2 illustrates a method for performing a write operation through an alignment operation in accordance with an embodiment.

FIG. 3 illustrates a method for performing a write operation when an alignment operation is not performed.

FIG. 4 is a flowchart illustrating an operating method of a memory system in accordance with an embodiment.

FIG. 5 is a flowchart illustrating a method in which an alignment processor performs an alignment operation.

FIG. 6 is a block diagram illustrating a controller in accordance with an embodiment.

FIG. 7 is a diagram illustrating a data processing system including a solid state drive (SSD) in accordance with an embodiment.

FIG. 8 is a diagram illustrating a data processing system including a memory system in accordance with an embodiment.

FIG. 9 is a diagram illustrating a data processing system including a memory system in accordance with an embodiment.

FIG. 10 is a diagram illustrating a network system including a memory system in accordance with an embodiment.

FIG. 11 is a block diagram illustrating a nonvolatile memory device included in a memory system in accordance with an embodiment.

### DETAILED DESCRIPTION

The advantages and characteristics of the present disclosure and a method for achieving the same are described through the following embodiments with reference to the accompanying drawings. However, the present disclosure is not limited to the embodiments described herein, but may be embodied in different ways. The present embodiments are provided to describe the present disclosure in detail, such that those skilled in the art to which the present disclosure pertains can make and use the present invention.

The present embodiments are not limited to specific shapes illustrated in the drawings, which shapes may be exaggerated for clarity. In this specification, specific terms are used. However, the terms are used to describe the present disclosure, not to limit the scope of the present disclosure.

In this specification, an expression such as ‘and/or’ may include one or more of components listed before/after the expression. Moreover, an expression such as ‘connected/coupled’ may indicate that one element is directly connected/coupled to another element or indirectly connected/coupled to another element through still another element. The terms of a singular form may include plural forms and vice versa, unless the context indicates otherwise. Furthermore, an open-ended term such as ‘include,’ ‘comprise,’ ‘including’ and ‘comprising’ may specify a component, step, operation and element, but do not exclude the presence or addition of one or more other components, steps, operations and elements.

Various embodiments will be described in detail with reference to the accompanying drawings,

FIG. 1 is a block diagram illustrating a memory system 10 in accordance with an embodiment.

The memory system 10 may be configured to store data provided from an external host device in response to a write request of the host device. Also, the memory system 10 may be configured to provide data stored therein to the host device in response to a read request of the host device.

The memory system 10 may be configured as any of a personal computer memory card international association (PCMCIA) card, a compact flash (CF) card, a smart media card, a memory stick, various multimedia cards (e.g., MMC, eMMC, RS-MMC, and MMC-Micro), various secure digital cards (e.g., SD, Mini-SD, and Micro-SD), a universal flash storage (UFS), a solid state drive (SSD) and the like.

The memory system 10 may include a controller 100 and nonvolatile memory devices NVM0 to NVM3.

The controller 100 may control overall operations of the memory system 10. The controller 100 may control the nonvolatile memory devices NVM0 to NVM3 to perform a foreground operation according to a request of the host device. The foreground operation may include an operation of writing data to the nonvolatile memory devices NVM0 to NVM3 and reading data from the nonvolatile memory devices NVM0 to NVM3 according to write and read requests of the host device, respectively.

The controller 100 may control the nonvolatile memory devices NVM0 to NVM3 to perform a background operation, which is internally required, independently of a request of the host device. The background operation may include any of a wear-leveling operation, a garbage collection operation, an erase operation and the like for the nonvolatile memory devices NVM0 to NVM3. The background operation may include the operation of writing data to the nonvolatile memory devices NVM0 to NVM3 and reading data from the nonvolatile memory devices NVM0 to NVM3, like the foreground operation.

The controller 100 may include an alignment processor 110.

When a write request for one or more logical addresses is received from the host device, the alignment processor 110 may determine whether a start logical address where a write operation is to be performed in a target nonvolatile memory device, among the logical addresses, satisfies an alignment condition. When the start logical address does not satisfy the alignment condition, the alignment processor 110 may perform an alignment operation to determine one or more target logical addresses among the logical addresses. The target logical addresses may indicate addresses where the write operation is to be performed in the target nonvolatile memory device. When the target logical addresses are determined through the alignment operation, the controller 100 may control the target nonvolatile memory device to perform the write operation on the target logical addresses.

Specifically, when transferring a write request for write data to the controller 100, the host device may transfer a logical address corresponding to the write data together with the write request. The logical address may indicate an address which the host device assigns to data. Also, the logical address may indicate an address which the host device uses to access the memory system 10. The logical address may be different from a physical address of a memory region, where write data is actually stored in the memory system 10. When a read request for the logical address is received from the host device, the controller 100 may map the logical address to the physical address, and thus read write data by accessing the memory region in which the write data is actually written.

In the present embodiment, the start logical address for determining whether the alignment condition is satisfied may be the first logical address of the logical addresses where the write operation needs to be performed. The alignment processor 110 may determine whether the start logical address coincides with any one of a plurality of reference logical addresses to determine whether the start logical address satisfies the alignment condition. When the start logical address coincides with any one of the plurality of reference logical addresses, the alignment processor 110 may determine that the start logical address satisfies the alignment condition. When the start logical address does not coincide with any one of the plurality of reference logical addresses, the alignment processor 110 may determine that the start logical address does not satisfy the alignment condition.

In order to describe the alignment condition in more detail, “alignment data size” may be first defined as follows. The alignment data size may indicate the maximum size of data which can be processed by a single nonvolatile memory device according to a single command. In other words, the alignment data size may indicate the maximum size of data which can be written/read by a single nonvolatile memory device according to a single command.

In addition, “alignment address number” may indicate the number of logical addresses corresponding to the alignment data size. That is, the alignment address number may indicate the maximum number of logical addresses which can be processed by a single nonvolatile memory device according to a single command. When the size of data corresponding to one logical address is less than the alignment data size, the alignment address number may be two or more.

In the present embodiment, the reference logical addresses which are compared to the start logical address in order to determine whether or not the alignment condition is satisfied may be logical addresses which are spaced set intervals apart from the first logical address of a logical address range used by the host device. The set interval may correspond to the alignment address number.

In an exemplary configuration, the memory system 10 supports a set logical address range for the host device, in which the first logical address starts from 0, the size of data corresponding to one logical address is 4 KB, and the alignment data size is 32 KB. When the alignment data size is 32 KB, the alignment address number may be set to 8. The reference logical addresses may include logical addresses which are spaced by 8 apart from the first logical address of 0, used by the host device, that is, multiples of 8.

Therefore, the alignment processor 110 may compare a start logical address of 16 with the reference logical addresses which are multiples of 8. Thus, the alignment processor 110 may determine that the start logical address of 16 satisfies the alignment condition. For example, the alignment processor 110 may compare a start logical address of 5 with the reference logical addresses which are multiples of 8. Thus, the alignment processor 110 may determine that the start logical address of 5 does not satisfy the alignment condition. The following embodiments will be described under the above-described supposition.

Referring back to FIG. 1, the alignment processor 110 may perform an alignment operation to decide target logical addresses, when the start logical address does not satisfy the alignment condition. The alignment processor 110 may select logical addresses as the target logical addresses. The logical addresses may range from the start logical address to the logical address just before the subsequent reference logical address. The subsequent reference logical address may indicate a reference logical address which immediately follows the start logical address, among the plurality of reference logical addresses, i.e., multiples of 8. For example, when the start logical address is 5, the subsequent reference logical address may be 8, and logical addresses of 5 to 7 may be selected as the target logical addresses. That is, the number of target logical addresses determined through the alignment operation may be less than the alignment address number, and write data corresponding to the target logical addresses may be less than the alignment data size.

Thus, in an embodiment, the alignment processor 110 may add dummy data to the write data corresponding to the target logical addresses. The dummy data may be added to the write data in order to satisfy the alignment data size.

The size of the dummy data may be equal to a difference between the alignment data size and the size of write data corresponding to the target logical addresses. In other words, the total size of the write data corresponding to the target logical addresses and the dummy data may be equal to the alignment data size. Then, the controller 100 may write the write data and the dummy data to the target nonvolatile memory device.

The target nonvolatile memory device may indicate a nonvolatile memory device where a write operation is to be performed according to a particular order, among the nonvolatile memory devices NVM0 to NVM3. For example, the controller 100 may sequentially store an alignment data size of data in the respective nonvolatile memory devices in order of the nonvolatile memory devices NVM0 to NVM3.

The alignment processor 110 may not perform the alignment operation when the start logical address satisfies the alignment condition. However, the alignment processor 110 may determine the target logical addresses among the logical addresses where the write operation is to be performed based on the alignment data size of 32 KB. Specifically, when the start logical address satisfies the alignment condition, the alignment processor 110 may select sequential logical addresses as the target logical addresses. For example, the sequential logical addresses may be corresponding to write data of 32 KB in the entire write data. In this example, eight sequential logical addresses corresponding to the alignment address number may be selected as the target logical addresses.

Once the alignment operation is performed, the start logical addresses where write operations are to be performed in the next target nonvolatile memory devices, respectively, may continuously satisfy the alignment condition. That is, the start logical addresses may be reference logical addresses.

The write operation may be performed on write data corresponding to the alignment data size of 32 KB in each of the nonvolatile memory devices, in order to provide the maximum write performance. The phrase “target data” may indicate data which the alignment processor 110 decides to write to the target nonvolatile memory device at a time. The target data may be an alignment data size of data. As described above, when the start logical address does not satisfy the alignment condition, the target data may include write data corresponding to the target logical addresses and dummy data. When the start logical address satisfies the alignment condition, the target data may include only write data corresponding to the target logical addresses without dummy data.

In an embodiment, when the total size of write data corresponding to a write request from the host device exceeds a set size, the alignment processor 110 may determine that the write data are sequential patterns. When the write data are sequential patterns, the logical addresses corresponding to the write data may be consecutive. However, when the total size of the write data corresponding to the write request from the host device does not exceed the set size, the alignment processor 110 may determine that the write data are random patterns.

In an embodiment, only when the write data are sequential patterns, the alignment processor 110 may determine whether the start logical address satisfies the alignment condition, and perform the alignment operation based on the determination result.

In an embodiment, when the write data are random patterns, the alignment processor 110 may neither determine whether the start logical address satisfies the alignment condition, nor perform the alignment operation. For example, when the write data are random patterns, the controller 100 may determine target data by merging the write data with other data stored in an internal buffer (not illustrated) of the controller 100, and write the target data to the target nonvolatile memory device. The target data may be merged to have the alignment data size.

The nonvolatile memory devices NVM0 to NVM3 may store data transferred from the controller 100 under control of the controller 100. Further, the nonvolatile memory devices NVM0 to NVM3 may read data stored therein and transfer the read data to the controller 100, under control of the controller 100. Each of the nonvolatile memory devices NVM0 to NVM3 may write and read a maximum size of data corresponding to the alignment data size in response to a single write and read command, respectively.

The nonvolatile memory device may include a flash memory, such as a NAND flash or a NOR flash, a ferroelectrics random access memory (FeRAM), a phase-change random access memory (PCRAM), a magnetoresistive random access memory (MRAM), and/or a resistive random access memory (ReRAM or RRAM).

Although FIG. 1 illustrates that the data storage device includes four nonvolatile memory devices NVM0 to NVM3, the number of nonvolatile memory devices included in the data storage device is not limited thereto. More generally, the data storage device may include one or more nonvolatile memory devices.

Thus, in accordance with the present embodiment, the alignment processor 110 may align sequential logical addresses corresponding to write requests with the reference logical addresses. That is, the write operation may be performed on an alignment address number of sequential logical addresses from a reference logical address in each of the nonvolatile memory devices. When the host device transfers sequential read requests for a set number of sequential logical addresses from a certain reference logical address, sequential read operations may be efficiently performed through a minimum of read commands as described below.

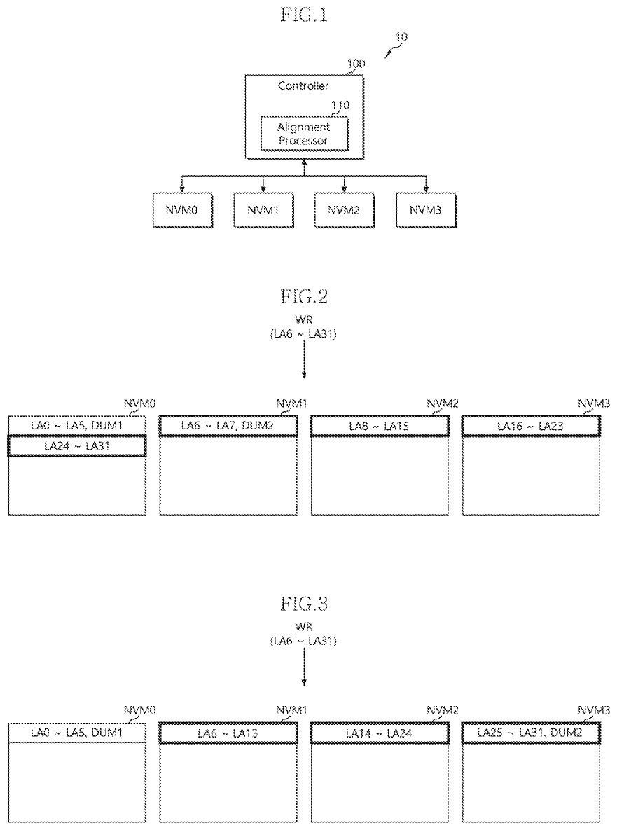

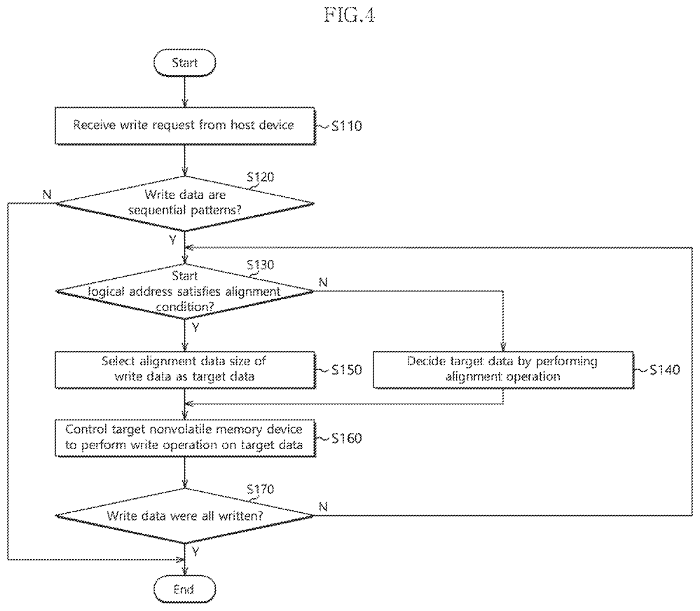

FIG. 2 illustrates a method for performing a write operation through an alignment operation in accordance with an embodiment. In FIG. 2 and subsequent figures, a number following symbol ‘LA’ may indicate a logical address.

Referring to FIG. 2, write data corresponding to logical addresses of 0 to 5 (i.e., LA0 to LA5) and dummy data DUM1 may be stored in the nonvolatile memory device NVM0. The write data corresponding to the logical addresses of 0 to 5 and the dummy data DUM1 may have the alignment data size.

Such a situation may occur when a flush request, for writing all data temporarily stored in the internal buffer of the controller 100 to the nonvolatile memory device NVM0 to NVM3, is received from the host device, for example. That is, in response to the flush request, the controller 100 may write the write data to the target nonvolatile memory device NVM0. The write data may be temporarily stored in the internal buffer and corresponding to the logical addresses of 0 to 5. However, the write data corresponding to the logical addresses of 0 to 5 may have a size of 24 KB. Therefore, the controller 100 may write the dummy data DUM1 of 8 KB to the target nonvolatile memory device NVM0 with the write data to satisfy the alignment data size.

Then, the controller 100 may receive a write request WR for logical addresses 6 to 31 (i.e., LA6 to LA31) from the host device. The alignment processor 110 may determine that write data of the write request WR are sequential patterns. Furthermore, the target nonvolatile memory device where the write operation is to be performed may be the nonvolatile memory device NVM1.

Therefore, the alignment processor 110 may determine whether the start logical address of 6 (i.e., LA6), where the write operation is to be performed in the target nonvolatile memory device NVM1, satisfies the alignment condition. As described above, the start logical address of 6 may be the first logical address of the logical addresses where the write operation is to be performed.

Since the start logical address of 6 does not coincide with any one of the reference logical addresses which are multiples of 8, the alignment processor 110 may determine that the start logical address of 6 does not satisfy the alignment condition.

Therefore, the alignment processor 110 may perform the alignment operation. Specifically, the alignment processor 110 may select logical addresses as the target logical addresses. For example, the logical addresses may range from the start logical address of 6 (i.e., LA6) to the logical address of 7 (i.e., LA7) just before the subsequent reference logical address of 8 (i.e., LA8). Then, the alignment processor 110 may add dummy data DUM2 to write data corresponding to the target logical addresses of 6 and 7 (i.e., LA6 and LA7). Since the write data corresponding to the target logical addresses of 6 and 7 have a size of 8 KB, the dummy data DUM2 may have a size of 24 KB to satisfy the alignment data size of 32 KB.

Therefore, the controller 100 may control the target nonvolatile memory device NVM1 to perform a write operation on the write data corresponding to the target logical addresses 6 and 7 (i.e., LA6 and LA7) and the dummy data DUM2.

Then, the controller 100 may repeat the above-described process on the remaining write data. Specifically, the initial logical address of 8 in the remaining write data may become a new start logical address. The alignment processor 110 may determine whether the start logical address of 8 (i.e., LA8), where a write operation is to be performed in the next target nonvolatile memory device NVM2, satisfies the alignment condition.

Since the start logical address of 8 (i.e., LA8) coincides with the reference logical address of 8 among multiples of 8, the alignment processor 110 may determine that the start logical address of 8 satisfies the alignment condition. Therefore, the controller 100 may select logical addresses of 8 to 15 (i.e., LA8 to LA15), corresponding to the alignment data size of 32 KB, as the target logical addresses.

As a result, the controller 100 may control the target nonvolatile memory device NVM2 to perform a write operation on the target logical addresses of 8 to 15 (i.e., LA8 to LA15). Similarly, the controller 100 may control the target nonvolatile memory device NVM3 to perform a write operation on target logical addresses of 16 to 23 (i.e., LA16 to LA23), and control the target nonvolatile memory device NVM0 to perform a write operation on target logical addresses of 24 to 31 (i.e., LA24 to LA31).

In short, as the alignment operation is performed on the target nonvolatile memory device NVM1, the following write operations may continuously satisfy the alignment condition. When the alignment condition is satisfied, the start logical address where the write operation is performed in each of the nonvolatile memory devices may be any one of the reference logical addresses.

FIG. 3 illustrates a method for performing a write operation when an alignment operation is not performed.

Referring to FIG. 3, a write operation may be performed on eight consecutive target logical addresses in each of the nonvolatile memory devices NVM1 to NVM3 (e.g., LA6 to LA13, LA14 to LA24, LA25 to LA31), unlike the method described with reference to FIG. 2. The start logical addresses of 6, 14 and 25 in the respective nonvolatile memory devices NVM1 to NVM3 may not satisfy the alignment condition.

In such a situation, the host device may transfer a read request for logical addresses of 8 to 15 (e.g., LA8 to LA15), for example. In a situation of FIG. 3, the controller 100 needs to perform a read operation on the nonvolatile memory devices NVM1 and NVM2 in response to the read request. That is, two sequential read commands need to be transferred to the nonvolatile memory devices NVM1 and NVM2, respectively. In the situation illustrated in FIG. 2, however, the controller 100 may perform a read operation only on the nonvolatile memory device NVM2 in response to the same read request. That is, only one sequential read command may be transferred to the nonvolatile memory device NVM2.

In short, after the alignment condition is satisfied, the start logical address where the write operation is performed in each of the nonvolatile memory devices may be any one of the reference logical addresses. Therefore, when the host device transfers sequential read requests for a set number of consecutive logical addresses from any one of the reference logical addresses, sequential read operations may be efficiently performed through a minimum of read commands as described above, which makes it possible to provide improved read performance.

FIG. 4 is a flowchart illustrating an operating method of a memory system, e.g., the memory system 10 of FIG. 1, in accordance with an embodiment.

Referring to FIG. 4, the controller 100 may receive a write request from the host device at step S110.

At step S120, the alignment processor 110 may determine whether the entire write data corresponding to the write request are sequential patterns. When it is determined that the write data are not sequential patterns (S120, N), the procedure may end. When it is determined that the write data are sequential patterns (S120, Y), the procedure may proceed to step S130.

At step S130, the alignment processor 110 may determine whether the start logical address where the write operation is to be performed in the target nonvolatile memory device satisfies the alignment condition. When it is determined that the start logical address does not satisfy the alignment condition (S130, N), the procedure may proceed to step S140. When it is determined that the start logical address satisfies the alignment condition (S130, Y), the procedure may proceed to step S150.

At step S140, the alignment processor 110 may determine or decide target data by performing the alignment operation.

At step S150, the alignment processor 110 may select some write data of the entire write data as the target data. The some write data may have a size corresponding to the alignment data size. For example, the alignment processor 110 may select write data as the target data. The write data may be corresponding to consecutive logical addresses and having the alignment data size.

At step S160, the controller 100 may control the target nonvolatile memory device to perform a write operation on the target data.

At step S170, the controller 100 may determine whether all write data corresponding to the write request were written. When it is determined that all such write data were written (S170, Y), the procedure may end. However, when it is determined that all such write data were not written (S170, N), the procedure may proceed to step S130. The initial logical address of the other logical addresses where write operations are not performed may be set to a new start logical address.

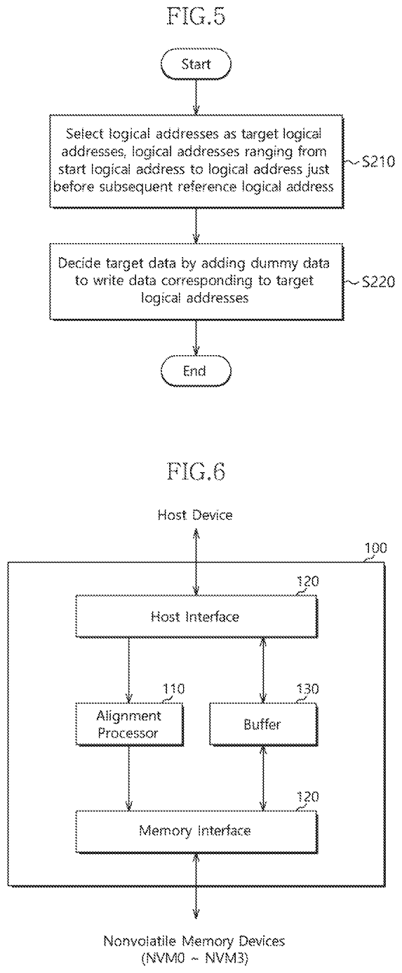

FIG. 5 is a flowchart illustrating a method of an alignment operation. The alignment operation may be performed by the alignment processor 110 of FIG. 1. The procedure of FIG. 5 may represent an embodiment of step S140 in FIG. 4.

Referring to FIG. 5, the alignment processor 110 may select logical addresses as the target logical addresses. For example, the logical addresses may range from the start logical address to the logical address just before the subsequent reference logical address.

At step S220, the alignment processor 110 may determine or decide the target data by adding dummy data to write data corresponding to the target logical addresses. The size of the dummy data may coincide with a difference between the alignment data size and the size of the write data corresponding to the target logical addresses. The target data may have the alignment data size.

FIG. 6 is a block diagram illustrating a controller, e.g., the controller of FIG. 1, in accordance with an embodiment.

Referring to FIG. 6, the controller 100 may include an alignment processor 110, a host interface 120, a buffer 130, and a memory interface 140.

The host interface 120 may communicate with an external host device. The host interface 120 may temporarily store data received from the host device in a buffer 130, and transfer the data temporarily stored in the buffer 130 to the host device.

In particular, the host interface 120 may receive a write request for one or more logical addresses and write data from the host device. The host interface 120 may transfer the write request to the alignment processor 110, and transfer the write data to the buffer 130.

The buffer 130 may temporarily store data transferred between the host device and the nonvolatile memory devices NVM0 to NVM3. Therefore, the buffer 130 may temporarily store the write data received from the host interface 120.

The alignment processor 110 may be operated as described with reference to FIG. 1. Thus, detailed description thereof is omitted here.

The memory interface 140 may be coupled to the nonvolatile memory devices NVM0 to NVM3, and control internal operations such as write and read operations of the nonvolatile memory devices NVM0 to NVM3. The memory interface 140 may generate a command for controlling the nonvolatile memory devices NVM0 to NVM3, and transfer the generated command to the nonvolatile memory devices NVM0 to NVM3. Furthermore, the memory interface 140 may transfer the data temporarily stored in the buffer 130 to the nonvolatile memory devices NVM0 to NVM3, and temporarily store data received from the nonvolatile memory devices NVM0 to NVM3 in the buffer 130.

In particular, the memory interface 140 may control the nonvolatile memory devices NVM0 to NVM3 to perform a write operation on target data determined by the alignment processor 110. For example, the memory interface 140 may transfer a write command and the target data to a target nonvolatile memory device among the nonvolatile memory devices NVM0 to NVM3. Further, the memory interface 140 may control the target nonvolatile memory device to perform a write operation on the target data. The memory interface 140 may transfer a single write command for the target data including write and dummy data to the target nonvolatile memory device to control the write operation of the target nonvolatile memory device.

FIG. 7 is a diagram illustrating a data processing system 1000 including a solid state drive (SSD) 1200 in accordance with an embodiment. Referring to FIG. 7, the data processing system 1000 may include a host device 1100 and the SSD 1200.

The SSD 1200 may include a controller 1210, a buffer memory device 1220, a plurality of nonvolatile memory devices 1231 to 123n, a power supply 1240, a signal connector 1250, and a power connector 1260.

The controller 1210 may control general operations of the SSD 1200. The controller 1210 may include a host interface 1211, a control component 1212, a random access memory 1213, an error correction code (ECC) component 1214, and a memory interface 1215.

The host interface 1211 may exchange a signal SGL with the host device 1100 through the signal connector 1250. The signal SGL may include a command, an address, data, and the like. The host interface 1211 may interface the host device 1100 and the SSD 1200 according to the protocol of the host device 1100. For example, the host interface 1211 may communicate with the host device 1100 through any one of standard interface protocols such as secure digital, universal serial bus (USB), multimedia card (MMC), embedded MMC (eMMC), personal computer memory card international association (PCMCIA), parallel advanced technology attachment (DATA), serial advanced technology attachment (SATA), small computer system interface (SCSI), serial attached SCSI (SAS), peripheral component interconnection (PCI), PCI express (PCI-e or PCIe) and universal flash storage (UFS).

The control component 1212 may analyze and process the signal SGL received from the host device 1100. The control component 1212 may control operations of internal function blocks according to firmware or software for driving the SSD 1200. The random access memory 1213 may be used as a working memory for driving such firmware or software.

The control component 1212 may include an alignment processor 1216. The alignment processor 1216 may be configured in the same manner as the alignment processor 110 shown in FIG. 1.

The ECC component 1214 may generate the parity data for data to be transmitted to at least one of the nonvolatile memory devices 1231 to 123n. The generated parity data may be stored together with the data in the nonvolatile memory devices 1231 to 123n. The ECC component 1214 may detect an error of the data read from at least one of the nonvolatile memory devices 1231 to 123n, based on the parity data. If a detected error is within a correctable range, the ECC component 1214 may correct the detected error.

The memory interface 1215 may provide control signals such as commands and addresses to at least one of the nonvolatile memory devices 1231 to 123n, according to control of the control component 1212. Moreover, the memory interface 1215 may exchange data with at least one of the nonvolatile memory devices 1231 to 123n, according to control of the control component 1212. For example, the memory interface 1215 may provide the data stored in the buffer memory device 1220, to at least one of the nonvolatile memory devices 1231 to 123n. Further, the memory interface 1215 may provide the data read from at least one of the nonvolatile memory devices 1231 to 123n, to the buffer memory device 1220.

The buffer memory device 1220 may temporarily store data to be stored in at least one of the nonvolatile memory devices 1231 to 123n. Further, the buffer memory device 1220 may temporarily store the data read from at least one of the nonvolatile memory devices 1231 to 123n. The data temporarily stored in the buffer memory device 1220 may be transmitted to the host device 1100 or at least one of the nonvolatile memory devices 1231 to 123n according to control of the controller 1210.

The nonvolatile memory devices 1231 to 123n may be used as storage media of the SSD 1200. The nonvolatile memory devices 1231 to 123n may be coupled with the controller 1210 through a plurality of channels CH1 to CHn, respectively. One or more nonvolatile memory devices may be coupled to one channel. The nonvolatile memory devices coupled to each channel may be coupled to the same signal bus and data bus.

The power supply 1240 may provide power PWR inputted through the power connector 1260, to the inside of the SSD 1200. The power supply 1240 may include an auxiliary power supply 1241. The auxiliary power supply 1241 may supply power to allow the SSD 1200 to be normally terminated when a sudden power-off occurs. The auxiliary power supply 1241 may include large capacity capacitors.

The signal connector 1250 may be configured as any of various types of connectors depending on an interface scheme between the host device 1100 and the SSD 1200.

The power connector 1260 may be configured as any of various types of connectors depending on a power supply scheme of the host device 1100.

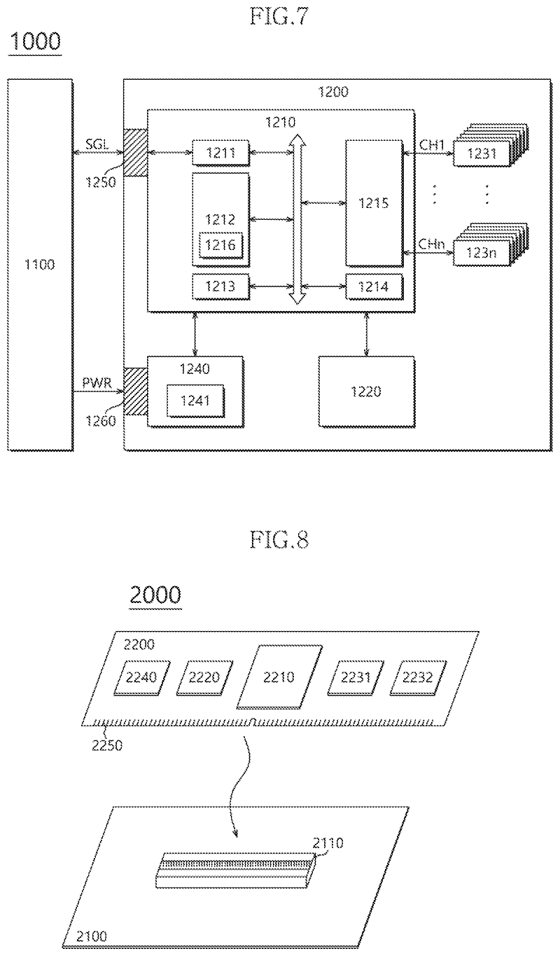

FIG. 8 is a diagram illustrating a data processing system 2000 including a memory system 2200 in accordance with an embodiment. Referring to FIG. 8, the data processing system 2000 may include a host device 2100 and the memory system 2200.

The host device 2100 may be configured in the form of a board such as a printed circuit board. Although not shown, the host device 2100 may include internal function blocks for performing the function of a host device.

The host device 2100 may include a connection terminal 2110 such as a socket, a slot or a connector. The memory system 2200 may be mounted to the connection terminal 2110.

The memory system 2200 may be configured in the form of a board such as a printed circuit board. The memory system 2200 may be referred to as a memory module or a memory card. The memory system 2200 may include a controller 2210, a buffer memory device 2220, nonvolatile memory devices 2231 and 2232, a power management integrated circuit (PMIC) 2240, and a connection terminal 2250.

The controller 2210 may control general operations of the memory system 2200. The controller 2210 may be configured in the same manner as the controller 1210 shown in FIG. 7.

The buffer memory device 2220 may temporarily store data to be stored in the nonvolatile memory devices 2231 and 2232. Further, the buffer memory device 2220 may temporarily store the data read from the nonvolatile memory devices 2231 and 2232. The data temporarily stored in the buffer memory device 2220 may be transmitted to the host device 2100 or the nonvolatile memory devices 2231 and 2232 according to control of the controller 2210.

The nonvolatile memory devices 2231 and 2232 may be used as storage media of the memory system 2200.

The PMIC 2240 may provide the power inputted through the connection terminal 2250, to the inside of the memory system 2200. The PMIC 2240 may manage the power of the memory system 2200 according to control of the controller 2210.

The connection terminal 2250 may be coupled to the connection terminal 2110 of the host device 2100. Through the connection terminal 2250, signals such as commands, addresses, data and so forth and power may be transferred between the host device 2100 and the memory system 2200. The connection terminal 2250 may be configured into various types depending on an interface scheme between the host device 2100 and the memory system 2200. The connection terminal 2250 may be disposed on any one side of the memory system 2200.

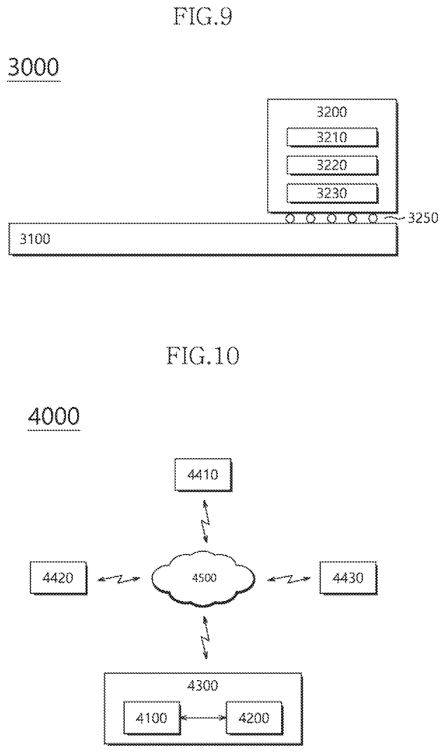

FIG. 9 is a diagram illustrating a data processing system 3000 including a memory system 3200 in accordance with an embodiment. Referring to FIG. 9, the data processing system 3000 may include a host device 3100 and the memory system 3200.

The host device 3100 may be configured in the form of a board such as a printed circuit board. Although not shown, the host device 3100 may include internal function blocks for performing the function of a host device.

The memory system 3200 may be configured in the form of a surface-mounting type package. The memory system 3200 may be mounted to the host device 3100 through solder balls 3250. The memory system 3200 may include a controller 3210, a buffer memory device 3220, and a nonvolatile memory device 3230.

The controller 3210 may control general operations of the memory system 3200. The controller 3210 may be configured in the same manner as the controller 1210 shown in FIG. 7.

The buffer memory device 3220 may temporarily store data to be stored in the nonvolatile memory device 3230. Further, the buffer memory device 3220 may temporarily store the data read from the nonvolatile memory device 3230. The data temporarily stored in the buffer memory device 3220 may be transmitted to the host device 3100 or the nonvolatile memory device 3230 according to control of the controller 3210.

The nonvolatile memory device 3230 may be used as the storage medium of the memory system 3200.

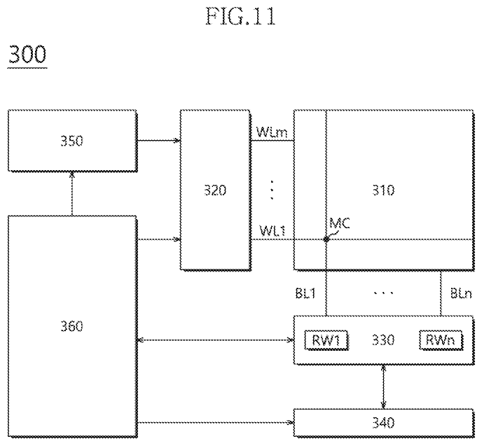

FIG. 10 is a diagram illustrating a network system 4000 including a memory system 4200 in accordance with an embodiment. Referring to FIG. 10, the network system 4000 may include a server system 4300 and a plurality of client systems 4410 to 4430 which are coupled through a network 4500.

The server system 4300 may service data in response to requests from the plurality of client systems 4410 to 4430. For example, the server system 4300 may store the data provided from the plurality of client systems 4410 to 4430. For another example, the server system 4300 may provide data to the plurality of client systems 4410 to 4430.

The server system 4300 may include a host device 4100 and the memory system 4200. The memory system 4200 may be configured by the memory system 100 shown in FIG. 1, the memory system 1200 shown in FIG. 7, the memory system 2200 shown in FIG. 8 or the memory system 3200 shown in FIG. 9.

FIG. 11 is a block diagram illustrating a nonvolatile memory device 300 included in a memory system in accordance with an embodiment. Referring to FIG. 11, the nonvolatile memory device 300 may include a memory cell array 310, a row decoder 320, a data read/write block 330, a column decoder 340, a voltage generator 350, and control logic 360.

The memory cell array 310 may include memory cells MC which are arranged at areas where word lines WL1 to WLm and bit lines BL1 to BLn intersect with each other.

The row decoder 320 may be coupled with the memory cell array 310 through the word lines WL1 to WLm. The row decoder 320 may operate according to control of the control logic 360. The row decoder 320 may decode an address provided from an external device (not shown). The row decoder 320 may select and drive the word lines WL1 to WLm, based on a decoding result. For instance, the row decoder 320 may provide a word line voltage provided from the voltage generator 350, to the word lines WL1 to WLm.

The data read/write block 330 may be coupled with the memory cell array 310 through the bit lines BL1 to BLn. The data read/write block 330 may include read/write circuits RW1 to RWn respectively corresponding to the bit lines BL1 to BLn. The data read/write block 330 may operate according to control of the control logic 360. The data read/write block 330 may operate as a write driver or a sense amplifier according to an operation mode. For example, the data read/write block 330 may operate as a write driver which stores data provided from the external device, in the memory cell array 310 in a write operation. For another example, the data read/write block 330 may operate as a sense amplifier which reads out data from the memory cell array 310 in a read operation.

The column decoder 340 may operate according to control of the control logic 360. The column decoder 340 may decode an address provided from the external device. The column decoder 340 may couple the read/write circuits RW1 to RWn of the data read/write block 330 respectively corresponding to the bit lines BL1 to BLn with data input/output lines or data input/output buffers, based on a decoding result.

The voltage generator 350 may generate voltages to be used in internal operations of the nonvolatile memory device 300. The voltages generated by the voltage generator 350 may be applied to the memory cells of the memory cell array 310. For example, a program voltage generated in a program operation may be applied to a word line of memory cells for which the program operation is to be performed. For another example, an erase voltage generated in an erase operation may be applied to a well area of memory cells for which the erase operation is to be performed. For still another example, a read voltage generated in a read operation may be applied to a word line of memory cells for which the read operation is to be performed.

The control logic 360 may control general operations of the nonvolatile memory device 300, based on control signals provided from the external device. For example, the control logic 360 may control operations of the nonvolatile memory device 300 such as read, write and erase operations of the nonvolatile memory device 300.

In accordance with embodiments of the present invention, the memory system and the operating method may perform sequential read operations with improved performance through the alignment operation.

While various embodiments have been illustrated and described, it will be understood by those skilled in the art in light of the present disclosure that the embodiments described are examples only. Accordingly, the operating method of a data storage device described herein should not be limited based on the described embodiments. Rather, the present invention encompasses any and all variations and modifications that fall within the scope of the claims.

What is claimed is:

1. An operating method of a memory system which includes a plurality of nonvolatile memory devices; and a controller configured to control the nonvolatile memory devices to store data therein, the operating method comprising:
receiving, by the controller, a write request for logical addresses from a host device;
determining, by the controller, whether a start logical address among the logical addresses satisfies an alignment condition, the start logical address indicating where a write operation is to be performed in a target nonvolatile memory device among the nonvolatile memory devices;
determining, by the controller, target data by determining one or more target logical addresses among the logical addresses through an alignment operation, when the start logical address does not satisfy the alignment condition; and
controlling, by the controller, the target nonvolatile memory device to perform the write operation on the target data.

2. The operating method according to claim 1, wherein the determining of whether the start logical address satisfies the alignment condition comprises determining, by the controller, that the start logical address satisfies the alignment condition, when the start logical address coincides with any one of a plurality of reference logical addresses.

3. The operating method according to claim 2, wherein the reference logical addresses comprise logical addresses which are spaced by an alignment address number apart from an initial logical address of a logical address range used by the host device,
the alignment address number indicates the number of logical addresses corresponding to an alignment data size, and
the alignment data size indicates a maximum size of data which are processed by a single nonvolatile memory device according to a single command.

4. The operating method according to claim 1, wherein the determining of the target data comprises:
selecting, by the controller, logical addresses ranging from the start logical address to a logical address immediately before a subsequent reference logical address, as the target logical addresses; and
adding, by the controller, dummy data to write data corresponding to the target logical addresses,
wherein the dummy data has a size corresponding to a difference between an alignment data size and a size of the write data.

5. The operating method according to claim 4, wherein the subsequent reference logical address indicates a reference logical address immediately following the start logical address, among a plurality of reference logical addresses.

6. The operating method according to claim 4, wherein the controlling of the target nonvolatile memory device to perform the write operation comprises transferring, by the controller, a single write command for the write data and the dummy data to the target nonvolatile memory device.

7. The operating method according to claim 1, wherein the determining of whether the start logical address satisfies the alignment condition comprises determining, by the controller, whether the start logical address satisfies the alignment condition, when write data corresponding to the logical addresses are sequential patterns.

8. A memory system comprising:
a plurality of nonvolatile memory devices; and
a controller configured to control the nonvolatile memory devices to store data therein,
wherein the controller receives a write request for logical addresses from a host device, determines whether a start logical address among the logical addresses satisfies an alignment condition, the start logical address indicating where a write operation is to be performed in a target nonvolatile memory device among the nonvolatile memory devices, determines target data by determining one or more target logical addresses among the logical addresses through an alignment operation when the start logical address does not satisfy the alignment condition, and controls the target nonvolatile memory device to perform the write operation on the target data.

9. The memory system according to claim 8, wherein, when the start logical address coincides with any one of a plurality of reference logical addresses, the controller determines that the start logical address satisfies the alignment condition.

10. The memory system according to claim 9, wherein the reference logical addresses comprise logical addresses which are spaced by an alignment address number apart from an initial logical address of a logical address range used by the host device,
the alignment address number indicates the number of logical addresses corresponding to an alignment data size, and
the alignment data size indicates a maximum size of data which are processed by a single nonvolatile memory device according to a single command.

11. The memory system according to claim 8, wherein, when the start logical address does not satisfy the alignment condition, the controller determines the target data by selecting logical addresses ranging from the start logical address to a logical address immediately before a subsequent reference logical address, as the target logical addresses, and adding dummy data to write data corresponding to the target logical addresses,
wherein the dummy data has a size corresponding to a difference between an alignment data size and a size of the write data.

12. The memory system according to claim 11, wherein the subsequent reference logical address indicates a reference logical address immediately following the start logical address, among a plurality of reference logical addresses.

13. The memory system according to claim 11, wherein, when controlling the target nonvolatile memory device to perform the write operation, the controller transfers a single write command for the write data and the dummy data to the target nonvolatile memory device.

14. The memory system according to claim 8, wherein, when write data corresponding to the logical addresses are sequential patterns, the controller determines whether the start logical address satisfies the alignment condition.

15. A memory system comprising:
a plurality of nonvolatile memory devices; and
a controller configured to control the nonvolatile memory devices under control of a host device,
wherein the controller comprises:
a host interface configured to receive a write request for logical addresses from the host device;
an alignment processor configured to compare a start logical address among the logical addresses with a plurality of reference logical addresses in response to the write request, the start logical address indicating where a write operation is to be performed in a target nonvolatile memory device among the nonvolatile memory devices, determine one or more target logical addresses among the logical addresses according to the comparison result, and determine target data based on the target logical addresses; and
a memory interface configured to control the target nonvolatile memory device to perform the write operation on the target data.

16. The memory system according to claim 15, wherein, when the start logical address coincides with any one of the reference logical addresses, the alignment processor selects write data as the target data, the write data having an alignment data size among write data corresponding to the write request.

17. The memory system according to claim 16, wherein the reference logical addresses comprise logical addresses which are spaced by an alignment address number apart from an initial logical address of a logical address range used by the host device,
the alignment address number indicates the number of logical addresses corresponding to the alignment data size, and
the alignment data size indicates a maximum size of data which are processed by a single nonvolatile memory device according to a single command.

18. The memory system according to claim 15, wherein, when the start logical address does not coincide with any one of the reference logical addresses, the alignment processor selects logical addresses ranging from the start logical address to a logical address immediately before a subsequent reference logical address, as the target logical addresses, and decides the target data by adding dummy data to write data corresponding to the target logical addresses, and
wherein the dummy data has a size corresponding to a difference between an alignment data size and a size of the write data.

19. The memory system according to claim 18, wherein the subsequent reference logical address indicates a reference logical address immediately following the start logical address, among the reference logical addresses.

20. The memory system according to claim 18, wherein, when controlling the target nonvolatile memory device to perform the write operation, the memory interface transfers a single write command for the write data and the dummy data to the target nonvolatile memory device.
